(19) United States
(12) Patent Application Publication
(10) Pub. No.: US 2026/0180669 A1
(43) Pub. Date: Jun. 25, 2026

(54) PIGGYBACKING ACCESSORY DEVICE INFORMATION OVER A USER-INITIATED NON-TERRESTRIAL NETWORK CONNECTION

(71) Applicant: Google LLC, Mountain View, CA (US)

(72) Inventors: Chinmay Dhodapkar, San Diego, CA (US); Ke Dong, San Jose, CA (US)

(21) Appl. No.: 19/416,676

(22) Filed: Dec. 11, 2025

Related U.S. Application Data
(60) Provisional application No. 63/736,254, filed on Dec. 19, 2024.

(51) Int. Cl. H04B 7/185; H04W 64/00

(52) U.S. Cl. CPC H04B 7/1851; H04W 64/00

(57) ABSTRACT

Techniques for piggybacking accessory device information over a user-initiated non-terrestrial network connection are disclosed herein. An example computing device includes a memory that stores instructions and one or more processors that execute the instructions to: receive a message to be sent by a radio that communicates through a non-terrestrial network associated with a plurality of transmission size ranges; determine, based on a size of the message, whether the message partially or fully fills a corresponding transmission size range; responsive to determining the message partially fills the corresponding transmission size range, include at least a portion of one or more indications of one or more wireless devices in a data transmission including the message, wherein the at least a portion of the one or more indications corresponds in size to an unfilled portion of the corresponding transmission size range; and transmit the data transmission to the non-terrestrial network.

### CROSS REFERENCE TO RELATED APPLICATION

This application claims the benefit of U.S. Provisional Patent Application No. 63/736,254, filed Dec. 19, 2024, the entire contents of which is incorporated herein by reference.

### BACKGROUND

Connected devices, such as sensors, wireless tracking tags, and other Internet of Things (IoT) devices, generally require a network connection to function as intended. For example, a connected device may collect sensor data or transmit location tracking beacons or other signals but such activities may be effectively useless without a network connection that the connected device can use to transfer information.

### SUMMARY

In general, aspects of the techniques of this disclosure are directed to piggybacking accessory device information over a user-initiated non-terrestrial network (NTN) connection. For example, a computing device may receive wireless signals from accessory devices (e.g., BLUETOOTH low energy (BLE) tags, narrow band Internet of Things (nb-IoT) sensors) within range of the computing device. The computing device may piggyback (e.g., include) the accessory device information in a data transmission including a user-initiated message and transmit the data transmission through an NTN. For example, the computing device may determine whether the message partially or fully fills a transmission size range corresponding to the NTN (e.g., determines if the size of the message is less than the maximum size of the transmission size range or if the size of the message is equal to the maximum size). When the message partially fills the data transmission, the computing device may piggyback the accessory device data in the portion of the data transmission that is unfilled by the message.

In accordance with the techniques disclosed herein, rather than allowing accessory devices to remain disconnected from a network, the disclosed techniques transmit accessory device information by piggybacking the accessory device information in user-initiated data transmissions. In this manner, accessory device information may be received by various services (e.g., device tracking services, nb-IoT services) even in areas or situations where terrestrial networks (e.g., cellular, WI-FI) are inaccessible. The receipt of such accessory device information may improve the responsiveness of computing systems hosting these services and may reduce consumption of computing resources (e.g., processor, memory) that would otherwise be required to compute (e.g., estimate) information that may instead be received and determined through the accessory device information.

In some aspects, the techniques described herein relate to a method including: detecting, by a computing device and based on one or more wireless signals received by a first radio from a plurality of radios in communication with the computing device, one or more wireless devices within a wireless range of the computing device; receiving, by the computing device, a message to be sent by a second radio from the plurality of radios, wherein the second radio communicates through a non-terrestrial network associated with a plurality of transmission size ranges; determining, by the computing device and based on a size of the message, whether the message partially or fully fills a corresponding transmission size range from the plurality of transmission size ranges; responsive to determining the message partially fills the corresponding transmission size range, including, by the computing device, at least a portion of one or more indications of the one or more wireless devices in a data transmission including the message, wherein the at least a portion of the one or more indications corresponds in size to a portion of the corresponding transmission size range that is unfilled by the message; and transmitting, by the computing device and using the second radio, the data transmission to the non-terrestrial network.

In some aspects, the techniques described herein relate to a computing device including a memory that stores instructions; and one or more processors that execute the instructions to: detect, based on one or more wireless signals received by a first radio from a plurality of radios in communication with the computing device, one or more wireless devices within a wireless range of the computing device; receive a message to be sent by a second radio from the plurality of radios, wherein the second radio communicates through a non-terrestrial network associated with a plurality of transmission size ranges; determine, based on a size of the message, whether the message partially or fully fills a corresponding transmission size range from the plurality of transmission size ranges; responsive to determining the message partially fills the corresponding transmission size range, include at least a portion of one or more indications of the one or more wireless devices in a data transmission including the message, wherein the at least a portion of the one or more indications corresponds in size to a portion of the corresponding transmission size range that is unfilled by the message; and transmit, using the second radio, the data transmission to the non-terrestrial network.

In some aspects, the techniques described herein relate to non-transitory computer-readable storage media including instructions, that when executed by one or more processors of a computing device, cause the one or more processors to: detect, based on one or more wireless signals received by a first radio from a plurality of radios in communication with the computing device, one or more wireless devices within a wireless range of the computing device; receive a message to be sent by a second radio from the plurality of radios, wherein the second radio communicates through a non-terrestrial network associated with a plurality of transmission size ranges; determine, based on a size of the message, whether the message partially or fully fills a corresponding transmission size range from the plurality of transmission size ranges; responsive to determining the message partially fills the corresponding transmission size range, include at least a portion of one or more indications of the one or more wireless devices in a data transmission including the message, wherein the at least a portion of the one or more indications corresponds in size to a portion of the corresponding transmission size range that is unfilled by the message; and transmit, using the second radio, the data transmission to the non-terrestrial network.

The details of one or more examples of the subject matter of this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a conceptual diagram illustrating an example environment for piggybacking accessory device information over a user initiated non-terrestrial network connection, in accordance with one or more aspects of the present disclosure.

FIG. 2 is a block diagram illustrating an example computing device, in accordance with one or more aspects of the present disclosure.

FIGS. 3A-3B are block diagrams illustrating an example process for piggybacking accessory device information over a user initiated non-terrestrial network connection, in accordance with one or more aspects of the present disclosure.

FIG. 4 is a block diagram illustrating an example communication session, in accordance with one or more aspects of the present disclosure.

FIG. 5 is a flowchart of an example process for piggybacking accessory device information over a user initiated non-terrestrial network connection, in accordance with one or more aspects of the present disclosure.

### DETAILED DESCRIPTION

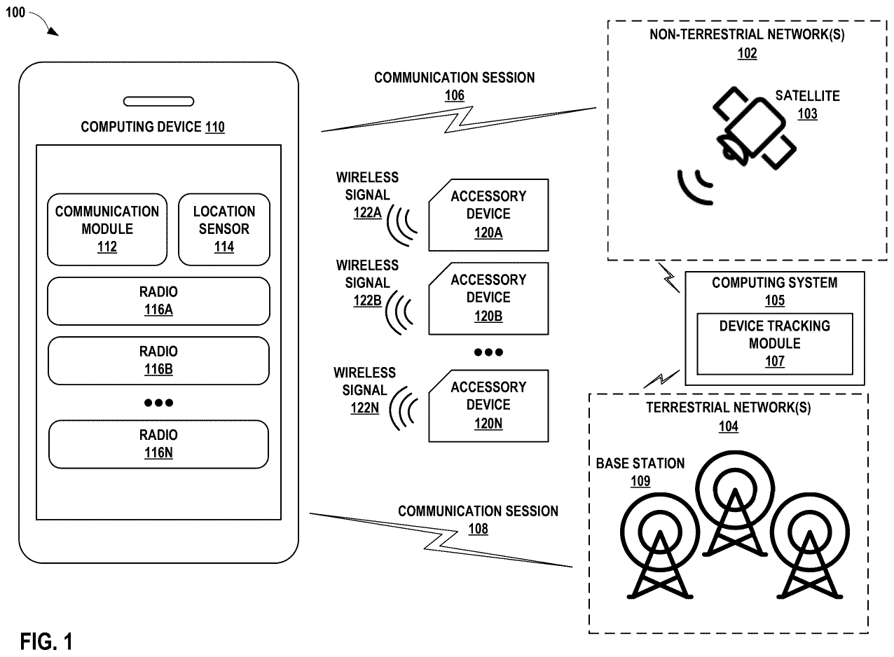

FIG. 1 is a conceptual diagram illustrating an example environment for piggybacking accessory device information over a user-initiated non-terrestrial network connection, in accordance with one or more aspects of the present disclosure. As can be seen, environment 100 may include a computing device 110, one or more accessory devices 120A-120N (collectively, “accessory devices 120”), and one or more non-terrestrial networks (NTNs) 102. Accessory devices 120 may represent wireless devices that may rely upon or otherwise use one or more computing devices, such as computing device 110, for particular types of communication. For example, accessory devices 120 may include location tracking tags (e.g., BLUETOOTH low energy (BLE) tags) for tracking the location of various objects (e.g., a user's belongings). These location tracking tags may rely upon computing device 110 to communicate the location of the location tracking tags such as to a device tracking service or other services (e.g., narrow band Internet of Things (nb-IoT) service), which may be provided by a computing system 105. In this manner, computing device 110 may represent an anchor device (e.g., a paired or bonded device) that accessory devices 120 may use to communicate with a network.

Other examples of accessory devices 120 include companion devices (e.g., smartwatches, fitness trackers, heart rate monitors, temperature sensors, asset trackers) and other devices capable of being paired or otherwise bonded with computing device 110), peripheral devices (e.g., wireless user input devices), or other devices that may wirelessly communicate with computing system 105 or another remote device or system through computing device 110. As used herein, accessory devices 120A-120N may also be referred to herein as “wireless devices 120A-120N (collectively, “wireless devices 120”).

Computing device 110 may be an example of a mobile phone, a tablet computer, a laptop computer, a wearable device, a gaming system, a media player, an e-book reader, or any other type of computing device. In the example of FIG. 1 for instance, computing device 110 represents a mobile phone. FIG. 1 illustrates a particular example of computing device 110, and many other examples of computing device 110 may be used in other instances and may include a subset of the components included in example computing device 110 or may include additional components not shown in FIG. 1.

Computing device 110 may include a plurality of radios 116A-116N (collectively, “radios 116”). Radios 116 of computing device 110 may communicate with external devices by transmitting and/or receiving communication signals, such as via one or more wireless networks or wireless connections. Each of radios 116 may respectively represent a physical network interface device (e.g., WI-FI adapter, BLUETOOTH adapter, cellular transceiver, Long Range (LoRa) transceiver, satellite transceiver) or any other type of device that can wirelessly send and/or receive information. Radios 116 may respectively communicate using various wireless frequencies and various communication protocols (e.g., WI-FI, BLUETOOTH, cellular, LoRa, satellite, long term evolution (LTE), nb-IoT). Though described above with respect to radios 116 that communicate wirelessly, in some examples, one or more of radios 116 may respectively represent a wired physical network interface device (e.g., Ethernet adapter, fiberoptic transceiver), or any other type of device that can send and/or receive information over a wired connection.

Computing device 110 may include radios 116 that respectively communicate with different networks or devices. For example, computing device 110 may include a first radio 116A that communicates with a first network or device, a second radio 116B that communicates with a second network or device, and an nth radio 116N that communicates with a nth network or device. With respect to the example of FIG. 1 for instance, radio 116A may represent a WI-FI adapter or cellular transceiver that communicates with one or more terrestrial networks 104, and radio 116B may represent a LoRa, satellite, or other NTN transceiver that communicates with one or more NTNs 102. Examples of terrestrial networks 104 include WI-FI networks and cellular networks. Examples of NTN networks 102 include satellite communication networks. Radios 116 may communicate with various networks or devices through communication sessions. For example, radio 116A may communicate with NTNs 102 through communication session 106 and radio 116B may communicate with terrestrial networks 104 through communication session 108. Communication sessions 106, 108 may represent one or more packets, units of data, or other data transmissions between computing device 110 and NTNs 102 and terrestrial networks 104, respectively.

One or more of radios 116 may communicate with one or more accessory devices 120. With respect to the example of FIG. 1 for instance, radio 116N may represent a radio (e.g., BLUETOOTH adapter, ultra-wideband sensor) capable of at least receiving wireless signals 122A-122N (collectively, “wireless signals 122”) from one or more of accessory devices 120. Radio 116N may, in some examples, also transmit wireless signals 122 to one or more of accessory devices 120. One or more of accessory devices 120 may transmit wireless signals 122 including a device discoverability advertisement, beacon, ping, or other message that radio 116N may receive. Accessory devices 120 may transmit wireless signals 122 using various wireless protocols. In a BLE example for instance, accessory devices 120 may transmit wireless signals 122 including a generic attribute profile (GATT) characteristic, identifier, or other message that radio 116N may receive.

One or more wireless signals of wireless signals 122 may carry (e.g., include) accessory device information that may identify respective accessory devices of accessory devices 120 that transmitted the one or more wireless signals. For example, accessory device 120A may transmit wireless signal 122A including a device identifier (ID) that uniquely identifies accessory device 120A, accessory device 120B transmit wireless signal 122B including a device ID that uniquely identifies accessory device 120B, accessory device 120N may transmit wireless signal 122N including a device ID that uniquely identifies accessory device 120N, and so on and so forth. The device ID may be a string of numeric, alphanumeric, or other characters or other data (e.g., binary data) that uniquely identifies a respective accessory device from accessory devices 120. In a BLE example for instance, the device ID may represent a suitable GATT characteristic or identifier.

In some examples, wireless signals 122 may indicate a location of the accessory device of accessory devices 120 that transmitted a wireless signal of wireless signals 122. Continuing the above example for instance, wireless signal 122A may include an indication of the distance between accessory device 120A and computing device 110, wireless signal 122B may include an indication of the distance between accessory device 120B and computing device 110, wireless signal 122N may include an indication of the distance between accessory device 120N and computing device 110, and so on and so forth. In some examples, the indication of distance may correspond to one or more indications of signal strength (e.g., received signal strength indicators (RSSIs), power level (e.g., decibel (dB) levels), BLUETOOTH channel sounding, WI-FI round trip time (RTT), or other characteristics of wireless signals 122 suitable for computing device 110 to determine a distance to an accessory device of accessory devices 120. An indication of signal strength may represent an absolute or relative measure of signal strength. Computing device 110 may determine the relative distance between computing device 110 and respective accessory devices 120 using one or more indications of signal strength, such as by correlating the signal strength to a corresponding distance. For example, lower indications of signal strength may correspond to longer distances and higher indications of signal strength may correspond to shorter distances.

Computing device 110 may include an indication of the location of accessory devices 120 in the accessory device information. For example, computing device 110 may determine a location (e.g., global navigation satellite system (GNSS) coordinates) of computing device 110 using location sensor 114. Examples of location sensor 114 include GNSS receivers, ultra-wideband sensors, and other suitable location sensing devices. Computing device 110 may include the location in the accessory device information for accessory devices 120. In some examples, computing device 110 may combine location information from wireless signals 122 with the location determined by location sensor 114, such as to more accurately reflect the actual location of accessory devices 120. For instance, computing device 110 may add or otherwise include the distance of accessory devices 120A indicated by one or more wireless signals 122 to the location determined by location sensor 114 to better pinpoint the location of accessory device 120A. In some examples, computing device 110 may apply the distance of respective accessory device 120A as an offset to the location determined by location sensor 114 to better pinpoint the location of accessory device 120A.

Radios 116 may communicate with a network through a network interface device of the network. The network interface device may represent a demarcation point for the network. For example, terrestrial networks 104 may include a network interface device in the form of a WI-FI router, WI-FI access point, cell site, WI-FI and/or cellular base station that is terrestrial (e.g., on Earth). The example of FIG. 1 illustrates a network interface device for terrestrial networks 104 in the form of a base station 109 for instance. As another example, NTNs 102 may include a network interface device in the form of a satellite 103 in orbit around the Earth (e.g., low earth orbit (LEO), geostationary orbit). NTNs 102, terrestrial networks 104, or both may include one or more network hubs, network switches, network routers, or any other network equipment, that are operatively inter-coupled thereby providing for the exchange of information between computing device 110 and computing system 105. Computing device 110 and computing system 105 may transmit and receive data through NTN 102 and/or terrestrial network 104 using any suitable communication techniques. Each of computing device 110 and computing system 105 may be operatively coupled to NTN 102 and/or terrestrial network 104 using respective communication links, such as WI-FI, BLUETOOTH, LoRa, cellular, satellite, or any other types of communication links.

As compared to terrestrial networks 104, which may be entirely terrestrial, NTNs 102 may include at least one non-terrestrial component (e.g., one or more orbiting satellites, such as satellite 103). NTNs 102 may also represent lower bandwidth networks relative to higher bandwidth terrestrial networks 104. For example, communication with NTNs 102 (e.g., satellite networks, nb-IoT networks) may have a maximum bandwidth of less than 10 kilobits per second (Kbps) (e.g., 1 Kbps, 2 Kbps, 3 Kbps) or lower depending on environmental conditions (e.g., cloud cover, obstructions). In contrast, communication with terrestrial networks 104 (e.g., WI-FI networks, cellular networks) may have a maximum bandwidth of well above 5 megabits per second (Mbps) (e.g., 10 Mbps, 100 Mbps, 500 Mbps, 1,000 Mbps). As such, NTNs 102 may represent lower bandwidth networks with a lower maximum bandwidth relative to terrestrial networks 104 and terrestrial networks 104 may represent higher bandwidth networks with a higher maximum bandwidth relative to NTNs 102.

NTNs 102 may also represent long range networks as compared to shorter range terrestrial networks 104. For example, terrestrial networks 104 may have a maximum range of 25 miles (e.g., a maximum distance of 25 miles between radio 116B and the closest network interface device of terrestrial networks 104). In contrast, NTNs 102 may have unlimited range (e.g., radio 116A may communicate with the closest network interface device of NTNs 102 from anywhere on Earth). As such, NTNs 102 may represent long range networks or unlimited range networks with a longer range relative to terrestrial networks 104 and terrestrial networks 104 may represent short range networks or limited range networks with a shorter range relative to NTNs 102. To support maintenance, replacement, and operation of satellite 103 which will typically be part of a constellation of satellites and other elements of NTNs 102, NTNs 102 may also represent higher (monetary) cost networks as compared to lower cost terrestrial networks 104. For example, NTNs 102 may charge $0.50 for a 50 byte transmission. Assuming this rate is constant, 1 kilobyte (KB) would cost $10.00 and 10 KBs would cost $100.00. In contrast, terrestrial networks 104 (e.g., cellular networks) may allow at least 1 gigabyte (GB) or even unlimited amounts of data to be transmitted for a comparable amount to sending 5-10 KBs through NTNs 102. In some examples, terrestrial networks 104 may allow unlimited amounts of data to be transmitted for free, such as in the case of a private or open WI-FI network. As such, NTNs 102 may represent higher cost networks (relative to terrestrial networks 104) with a higher cost (relative to terrestrial networks 104) and terrestrial networks 104 may represent lower cost networks with lower costs (relative to NTNs 102).

Due to the lower bandwidth, higher cost, and/or longer range (e.g., global accessibility) of NTNs 102, NTNs 102 may be considered backup networks. For example, NTNs 102 may be used as networks of last resort (e.g., used when terrestrial networks 104 are inaccessible) mainly due to the higher cost of data transmission. As such, computing device 110 may communicate through NTN 102 in situations where computing device 110 is in a dead zone (e.g., situations where terrestrial networks 104 are out of range or otherwise inaccessible). For instance, terrestrial networks 104 may be inaccessible when computing device 110 is in a remote area (e.g., dead zone, remote or isolated areas, wilderness, mountainous areas, outdoor recreational areas, at sea) beyond the range of any network interface device of terrestrial networks 104. Due to the lower bandwidth and/or higher cost of communicating through NTNs, a user of computing device 110 may only use NTNs 102 sparingly. For example, the user may only send messages from computing device 110 using NTNs 102 after considering the temporal cost (e.g., transmission time due to lower bandwidth of NTNs 102), monetary cost, or both incurred by communicating through NTNs 102.

Computing device 110 may include communication module 112. Communication module 112 may piggyback accessory device information over a user-initiated NTN connection. For example, communication module 112 may cause computing device 110 to transmit data to NTN 102 according to a tiered transmission structure. For instance, the plurality of transmission size ranges may each have a minimum size and a maximum size larger than the minimum size. The plurality of transmission size ranges may together form a sequence where each successive transmission size range has a minimum size larger than the maximum size of the preceding transmission size range. An example of a tiered transmission structure including a plurality of transmission size ranges is provided in Table 1 below. The largest maximum size in a tiered transmission structure may represent a maximum packet size (e.g., 300 bytes) imposed by one or more of NTNs 102. Though described in connection with piggybacking accessory device information, communication module 112 may piggyback other data, including data carried by nb-IoT networks, rather than accessory device information in some examples.

TABLE 1

| Transmission | Minimum | Maximum |
|---|---|---|
| Size Range | Size (bytes) | Size (bytes) |
| 1 | 1 | 50 |
| 2 | 51 | 200 |
| 3 | 201 | 300 |

Communication module 112 may use the unfilled portion of a transmission size range to piggyback (e.g., include) data, such as accessory device information, with a data transmission. For example, computing device 110 may receive a user-initiated message (e.g., text message) for transmission through NTN 102 from the user. Communication module 112 may identify a corresponding transmission size range for the message. For example, communication module 112 may identify the transmission size range from the plurality of transmission size ranges that encompasses the size of the message. Communication module 112 may determine the size of the message for such purposes.

To illustrate, assuming communication module 112 determines a message has a message size of 30 bytes (e.g., a text message of 30 bytes), communication module 112 may determine transmission size range 1 corresponds to the size of the message in that message size falls between the minimum size and maximum size of transmission size range 1. Communication module 112 may determine whether the message size partially or fully fills the corresponding transmission size range. Continuing the above example for instance, communication module 112 may determine the message partially fills transmission size range 1 in that the message size is 30 bytes and the maximum size of transmission size range 1 is 50 bytes. In response to determining that the message partially fills the corresponding transmission size range, communication module 112 may determine an unfilled portion of the corresponding transmission size range. Continuing the above example for instance, communication module 112 may determine the unfilled portion of transmission size range 1 is 20 bytes. Communication module 112 may piggyback (e.g., include) accessory device information in the unfilled portion of the corresponding transmission size range. Communication module 112 may generate a data transmission that fully fills the corresponding transmission size in this manner. With respect to the above example for instance, communication module 112 may generate a data transmission including the 30 byte message and up to 20 bytes of the accessory device information thereby filling the 50 byte maximum size of transmission size range 1.

Communication module 112 may include, in the data transmission, an indication of the location of accessory devices 120 with the accessory device information. For example, communication module 112 may include an indication of the location of accessory devices 120 in the accessory device information. Communication module 112 may determine the location of accessory devices 120 based on a location determined by location sensor 114 and/or location information from wireless signals 122, such as described above.

Communication module 112 may use radio 116B to transmit the data transmission through NTN 102. In some examples, communication module 112 may use radio 116B and NTN 102 only after determining terrestrial networks 104 are inaccessible. The determination that terrestrial networks 104 are inaccessible may include determining, by communication module 112, a lack of any available terrestrial networks or a lack of a reliable connection to a terrestrial network. For example, communication module 112 may determine whether one or more other radios of radios 116 are currently connected to terrestrial network 104. Communication module 112 may refrain from transmitting the data transmission through NTN 102 when the one or more other radios are connected to terrestrial network 104. As such, communication module 112 may transmit the data transmission through NTN 102 when none of radios 116 have a connection to terrestrial networks 104.

NTN 102 may route the accessory device information piggybacked in the data transmission from communication module 112 to computing system 105, such as to a device tracking service implemented by device tracking module 107 at computing system 105. Device tracking module 107 may record device tracking information including the location (e.g., GNSS coordinates) of individual accessory devices 120 to allow the location of accessory devices 120 to be tracked. In this manner, one or more users may use the device tracking service to locate their devices. For example, a user may send, such as through a computing device (e.g., computing device 110), a query to device tracking module 107 that includes a device ID or other identifier of accessory device 120A. Device tracking module 107 may search the device tracking information using the device ID of accessory device 120A to retrieve a location (e.g., the last recorded location) and/or location history for accessory device 120A from a storage device of computing system 105.

Computing system 105 may be any suitable remote computing system, such as one or more desktop computers, laptop computers, mainframes, servers, cloud computing systems, virtual machines, etc. capable of sending and receiving information via NTNs 102 and/or other networks, including terrestrial networks 104. In some examples, computing system 105 may represent a cloud computing system. That is, in some examples, computing system 105 may be a distributed and/or remote computing system. One or more computing devices, such as computing device 110, may access device tracking service or other services provided by computing system 105 by communicating with computing system 105.

Computing system 105 may include one or more processors, one or more communication devices, and one or more memory devices. A memory device of computing system 105 may include an operating system, which may provide an execution environment for device tracking module 107 that, when executed by one or more processors, provides a device tracking service as described herein. A memory device of computing system 130 may store various data, such as in a structured or unstructured format. For example, the memory device may include a database that stores device tracking information including location data (e.g., GNSS coordinates) or other data about respective accessory devices 120.

Computing system 105 and computing device 110 may operate in conjunction to provide the device tracking service. For example, communication module 112 of computing device 110 may piggyback accessory device information identifying a location for one or more of accessory devices 120. As described above, device tracking module 107 of computing system 105 may store the accessory device information as device tracking information, such as to a storage device or storage system of computing system 105. Device tracking module 107 may receive, from computing device 110, one or more queries for location or other information about one or more accessory devices of accessory devices 120 as may be identified by respective device IDs in the one or more queries. Device tracking module 107 may retrieve the device tracking information for the one or more accessory devices and send the retrieved device tracking information to computing device 110. Computing device 110 may present the retrieved device tracking information, such as in one or more user interfaces presented through a user interface device or other suitable output device of computing device 110. For example, the one or more user interfaces may present the location of the one or more accessory devices as recorded in the device tracking information. Though described with respect to a device tracking service, computing system 105 may provide various services including nb-IoT services that monitor, manage, or otherwise provide services to various Internet of Things (IoT) devices (e.g., sensing devices, metering devices).

Piggybacking the accessory device information may improve the responsiveness of computing system 105 in tracking the location of accessory devices 120. For example, computing device 110 may communicate with accessory devices 120 where terrestrial networks 104 are inaccessible and piggyback accessory device information identifying accessory devices 120 in user-initiated messages that computing device 110 may transmit through NTN 102. NTN 102 may route the accessory device information to computing system 105 and computing system 105 may update the location of accessory devices 120 in one or more records stored to computing system 105 based on the accessory device information from computing device 110. As described above, the accessory device information may indicate a location for one or more of accessory devices 120. In this manner, the location of accessory devices 120 may be more frequently updated at computing system 105 thereby improving the responsiveness (e.g., reducing the latency) of location information for accessory devices provided by computing system 105. In some cases, accessory devices 120 may only have connectivity through computing device 110 and NTN 102. For example, accessory devices 120 may be in a remote area or other dead zone with no access to terrestrial networks 104. In these cases, without the piggybacking of accessory device information of the techniques described herein, computing system 105 may not receive any accessory device information for accessory devices 120 effectively rendering accessory devices 120 lost and/or inoperative.

The connectivity provided through piggybacking of accessory device information may improve the operation of nb-IoT and other services that communicate small amounts of data over lower bandwidth connections. As described above, by piggybacking accessory device information received from accessory devices 120 computing device 110 may enable accessory devices 120 to more frequently communicate accessory device information to an nb-IoT service. In some cases, by piggybacking accessory device information received from accessory devices 120 computing device 110 may enable the only avenue of communication between accessory devices 120 and an nb-IoT service, such as an nb-IoT service at computing system 105. In this manner, computing device 110 may improve the operation of computing system 105 in providing nb-IoT and similar services. For example, rather than calculating (e.g., estimating) an outcome, such as through previously collected or other representative data, statistical techniques, or the like, computing system 105 may receive accessory device information that indicates the outcome from accessory devices 120. For instance, rather than calculating when to refill a water, gas, or other storage tank, computing system 105 may receive accessory device information from one or more accessory devices 120 that indicates when the storage tank is empty or near empty. In this manner, computing resources (e.g., processing and memory resources) at computing system 105 that would otherwise be consumed for these calculations may be reduced or eliminated.

NTNs 102 may assess data transmission fees based on data volume according to a tiered transmission structure. For example, NTN 102 may assess data transmission fees according to the tiered transmission structure and transmission size ranges of the example described above with respect to Table 1. As such, NTN 102 may charge a first amount to transmit up to a first quantity of bytes, a second amount to up to a second quantity of bytes, a third amount to transmit up to a third quantity of bytes, and so on and so forth. NTN 102 may assess the full fee for the transmission size range corresponding to the size of the data transmission (e.g., the transmission size range encompassing the size of the data transmission) even when a data transmission is less than the maximum size for the transmission size range. Referring to the example of Table 1 for instance, NTN 102 may assess $0.50 for any data transmission less than 50 bytes (e.g., 10 bytes, 30 bytes, 40 bytes), assess $0.70 for any data transmission more than 50 bytes and less than 200 bytes (e.g., 70 bytes, 100 bytes, 160 bytes), and assess $0.80 for any data transmission more than 200 bytes and less than 300 bytes (e.g., 220 bytes, 250 bytes, 290 bytes). By piggybacking accessory device information according to a tiered transmission structure (e.g., according to corresponding transmission size ranges), computing device 110 may transmit accessory device information without cost to the user of computing device 110. As such, the operation of computing system 105 may be improved, such as described above, without incurring data transmission costs from NTNs 102.

In some examples, communication module 112 may piggyback accessory device information in portions. For example, communication module 112 may split or divide accessory device information to occupy one or more unfilled portions of multiple data transmissions. For instance, assuming for illustrative purposes that the accessory device information is 50 bytes and a first data transmission has an unfilled portion of 30 bytes, communication module 112 may split the accessory device information into a 30 byte portion and a 20 byte portion. Communication module 112 may piggyback the 30 byte portion of the accessory device information in the first data transmission and piggyback the remaining 20 byte portion of the accessory device information in one or more subsequent data transmissions. For example, communication module 112 may piggyback the 20 byte portion in a second data transmission that has an unfilled portion of at least 20 bytes.

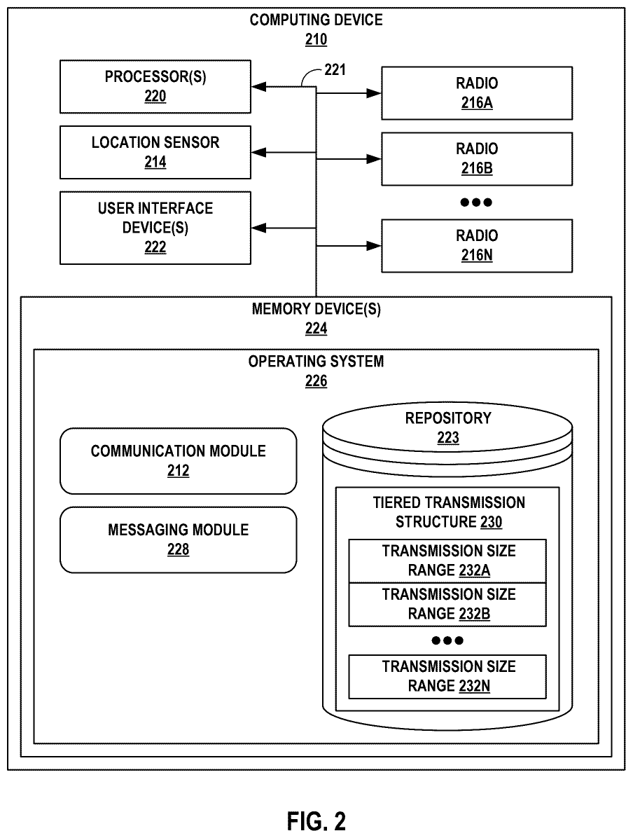

FIG. 2 is a block diagram illustrating an example computing device, in accordance with one or more aspects of the present disclosure. FIG. 2 illustrates a particular example of computing device 210, and many other examples of computing device 210 may be used in other instances which may include a subset of the components included in computing device 210 or may include additional components not shown in FIG. 2. Aspects of FIG. 2 may be described in the context of FIG. 1. For example, computing device 210, communication module 212, location sensor 214, and radios 216A-216N (collectively, “radios 216”) of FIG. 2 may respectively be examples of computing device 110, communication module 112, location sensor 114, and radios 116 of FIG. 1.

Computing device 210 may include one or more processors 220, location sensor 214, one or more user interface devices 222, radios 216, and one or more memory devices 224. One or more memory devices 224 of computing device 110 may include operating system 226, communication module 212, and messaging module 228. Communication channels 221 may interconnect each of the components 214, 216, 220, 222, 224 for inter-component communications (physically, communicatively, and/or operatively). In some examples, communication channels 221 may include a system bus, a network connection, an inter-process communication data structure, or any other method for communicating data.

User interface device 222 of computing device 210 may be hardware that functions as an input and/or output device for computing device 210. For example, user interface device 222 may include a display component, which may be a screen at which information is displayed by user interface device 222 and a presence-sensitive input device that may detect an object at and/or near the display component. In some examples, user interface device 222 may include one or more input devices that receive input. Examples of input include tactile, audio, and video input. Input devices of user interface device 222, in one example, includes a presence-sensitive display, touch-sensitive screen, mouse, keyboard, voice responsive system, video camera, microphone or any other type of device for detecting input from a human or machine. User interface device 222 may include one or more output devices that generate output. Examples of output include tactile, audio, and video output. Output devices user interface device 222, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

Location sensor 214 may collect or obtain sensor data related to the location of computing device 210. In some examples, location sensor 214 may be a sensing or input component that obtains physical position, movement, and/or location of computing device 210. Location sensor 214 may represent sensing devices including GNSS receivers, ultra-wideband sensors, near field communication (NFC) sensors, or other suitable location sensing devices. Location sensor 214 may output sensor data, including metrics, measurements, or other data, corresponding to the location of computing device 210. For example, an ultra-wideband or proximity sensor may output sensor data indicating the distance or position of computing device 210 relative to one or more of accessory devices 120 or other objects and/or devices, a GNSS may output sensor information indicating the location (e.g., latitude, longitude) of computing device 210.

One or more processors 220 may implement functionality and/or execute instructions within computing device 210. For example, one or more processors 220 of computing device 210 may receive and execute instructions stored by one or more memory devices 224 that execute the functionality of operating system 226, communication module 212, and/or messaging module 228. The instructions executed by one or more processors 220 may cause computing device 210 to store information within one or more memory devices 224 during program execution. Examples of one or more processors 220 include general purpose processors (e.g., central processing units (CPUs)), accelerators (e.g., graphics processing units (GPUs), neural processing units (NPUs)), application processors, display controllers, sensor hubs, and any other hardware configured to function as a processing unit. One or more processors 220 may execute instructions of operating system 226, communication module 212, and messaging module 228 to perform actions or functions. That is, operating system 226, communication module 212, and messaging module 228 may be operable by one or more processors 220 to perform various actions or functions of computing device 210.

One or more memory devices 224 within computing device 210 may store information for processing during operation of computing device 210. That is, computing device 210 may store data accessed by operating system 226, communication module 212, and messaging module 228 during execution at computing device 210. For example, one or more memory devices 224 may store a tiered transmission structure 230 including one or more transmission size ranges 232A-232N (collectively, “transmission size ranges 232”), and other data, or various subsets thereof. A transmission size range of transmission size ranges 232 may include at least an indication of a range from a minimum size and a maximum size to define the lower and upper bounds of the transmission size range, such as shown above in Table 1. As another example, one or more memory devices 224 may store messages managed by messaging module 228, such as messages a user wishes to send (e.g., user-initiated messages), messages to the user that computing device 210 has received from other users, messages the user has sent from computing device 210, or the like.

Memory device 224 may store tiered transmission structure 230, one or more transmission size ranges 232, messages, and other data, or various subsets thereof in various ways. As shown in the example of FIG. 2 for instance, memory device 224 may store tiered transmission structure 230, one or more transmission size ranges 232, or both to a repository 223. Repository 223 may represent a database or other data storage format. Examples of repository 223 include files (e.g., comma separated value (CSV) files, JavaScript object notation (JSON) files, software query language (SQL) databases, not only SQL (NoSQL) databases, and other structured or unstructured data formats. Though shown as storing tiered transmission structure 230 and one or more transmission size ranges 232, repository 223 may store messages and/or other data.

In some examples, memory device 224 may represent a temporary memory, meaning that a primary purpose of memory device 224 may not be long-term storage. One or more memory devices 224 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more memory devices 224, in some examples, also include one or more computer-readable storage media. One or more memory devices 224 may be configured to store larger amounts of information than volatile memory. One or more memory devices 224 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. As described above, one or more memory devices 224 may store program instructions and/or information (e.g., data) associated with operating system 226, communication module 212, and/or messaging module 228.

Communication module 212, may execute at one or more processors 220 to perform functions related to piggybacking accessory device information. In some examples, communication module 212 may operate in conjunction with messaging module 228. For example, messaging module 228 may execute at one or more processors 220 to receive user-initiated messages, or indications thereof, from a user of computing device 210 (e.g., messages the user wishes to send). Examples of user-initiated messages include text messages (e.g., short message service (SMS) messages, rich communication services (RCS) messages), emergency messages (e.g., satellite SOS messages), location sharing messages (e.g., GNSS coordinates), person-to-person (P2P) messages, and other messages.

Messaging module 228 may generate one or more user interfaces including user interface elements (e.g., buttons, switches, toggles, text input or other input fields, controls) that user interface device 222 may present to the user, such as through a display or other output component of user interface device 222. The user interface elements may also or alternatively receive input from the user, such as user input corresponding to the content of user-initiated messages, commands to send user-initiated messages, or other user input. As such, a user-initiated message may include message content inputted by the user, a command or other indication from the user to send the user-initiated message, or both. In some examples, the user-initiated message may be sent with machine generated content rather than message content inputted by the user. For example, computing device 110 may generate location data (e.g., GNSS coordinates) based on output of location sensor 214, which messaging module 228 may use as message content for a user-initiated message. In such a case, the user may input a command (e.g., tap a “Share Location” button) or provide another indication to send the user-initiated message including the location data. Computing device 110 may transmit the user-initiated message with the location data as the message content rather than message content inputted by the user.

Communication module 212 may detect a user-initiated message through messaging module 228. For example, communication module 212 may detect when a user-initiated message is inputted by a user, such as in a user interface generated by messaging module 228 or when a command or other indication to send the user-initiated message is received. As another example, communication module 212 may detect a user-initiated message by detecting when communication session 106 with NTN 102 is initiated, such as by radio 216B. In some cases, rather than allowing computing device 110 to “camp” (e.g., remain connected) to NTN 102, NTN 102 may require the user to point computing device 110 towards satellite 103 to initiate and/or facilitate communication session 106 (e.g., connect to NTN 102). As such, communication module 212 may detect a user-initiated message when computing device 110 is pointed or otherwise controlled to initiate communication session 106 with NTN 102.

In response to detecting a user-initiated message, communication module 212 may determine whether accessory device information may be piggybacked (e.g., included) in a data transmission including the user-initiated message. For example, communication module 212 may determine the size of the user-initiated message. For instance, communication module 212 may determine the size of the user-initiated message based on the number of bytes the message content of the user-initiated message occupies.

Communication module 212 may identify a corresponding transmission size range from transmission size ranges 232 based on the size of the user-initiated message. Communication module 212 may identify the corresponding transmission size range by identifying a transmission size range from transmission size ranges 232 where the size of the user-initiated message is between the minimum of the transmission size range (e.g., the minimum size of the transmission size range) and the maximum of the transmission size range (e.g., the maximum size of the transmission size range). To illustrate, assuming transmission size range 232A, transmission size range 232B, and transmission size range 232N correspond respectively to transmission size range 1, transmission size range 2, and transmission size range 3 of Table 1 above, transmission size range 232A would be the corresponding transmission size range for a user-initiated message of 40 bytes, transmission size range 232B would be the corresponding transmission size range for a user-initiated message of 170 bytes, and transmission size range 232N would be the corresponding transmission size range for a user-initiated message of 210 bytes.

To determine whether to piggyback accessory device information, communication module 212 may determine whether the size of the user-initiated message partially or fully fills the corresponding transmission size range. Communication module 212 may determine to piggyback the accessory device information when the corresponding transmission size range is partially filled (e.g., not fully filled). Communication module 212 may determine the unfilled portion of the corresponding transmission size range. Continuing the above example for instance, communication module 212 may determine the unfilled portion of transmission size range 232A is 10 bytes. Communication module 212 may generate a data transmission corresponding to the maximum size of the corresponding transmission size range and include the accessory device information in the unfilled portion of the corresponding transmission size range. With respect to the above example for instance, communication module 212 may generate a data transmission of 50 bytes where the user-initiated message occupies 40 bytes and the accessory device information occupies up to 10 bytes of the portion of the data transmission that is unfilled by the user-initiated message. Communication module 212 may transmit the data transmission to NTN 102, such as through radio 216A. Radio 216A of FIG. 2 may be an example of radio 116A of FIG. 1.

In some cases, the amount of accessory device information may exceed the unfilled portion of a first data transmission. In these cases, communication module 212 may send such accessory device information in sections or portions. For example, assuming the accessory device information is 30 bytes, communication module 212 may send 10 bytes of the accessory device information with the 40 byte user-initiated message from the above example and subsequently send the remaining 20 bytes of the accessory device information in unfilled portions of data transmissions corresponding to one or more subsequent user-initiated messages. For example, the subsequent data transmission may include a subsequent user-initiated message of 150 bytes, leaving 50 bytes unfilled in the 200 byte corresponding transmission size range, transmission size range 232B. Communication module 212 may include the remaining 20 bytes of the accessory device information in the 50 byte unfilled portion of the data transmission. Communication module 212 may send the data transmission to NTN 102, such as through radio 216A, and thereby complete transmission of the entire 30 bytes of accessory device information.

In some examples, communication module 212 may refrain from piggybacking accessory device information based on a location of computing device 210. For example, communication module 212 may refrain from piggybacking accessory device information when computing device 210 has not moved beyond a distance threshold (e.g., has moved a distance that is less than or equal to the distance threshold) from a location where communication module 212 previously transmitted the accessory device information. Communication module 212 may determine a location of computing device 110 using location sensor 214 and store a record of such location when communication module 212 transmits accessory device information. Communication module 212 may compare a current location, which may also be determined by location sensor 214, to the stored location to determine whether computing device 110 has moved beyond a distance threshold (e.g., 100 feet (ft), 300 ft, 500 ft) relative to the previously stored location. Communication module 212 may refrain from piggybacking and thus refrain from transmitting the accessory device information when computing device 110 has not moved beyond the distance threshold from the stored location. In this manner, communication module 212 optimizes (e.g., conserves) use of NTN 102 bandwidth by not piggybacking accessory device information when the accessory device information was previously sent from the same vicinity (e.g., from within the distance threshold) as such accessory device information may be generally duplicative or redundant since computing device 110 has remained relatively stationary.

As described above, NTN 102 may route accessory device information to computing system 105 for use, such as for use with a device tracking or nb-IoT service hosted by computing system 105. Communication module 212 and computing system 105 may be capable of handling partial transmission of accessory device information. For example, communication module 212 may indicate to computing system 105 the total size of the accessory device information communication device 212 is transmitting and computing system 105 may combine portions of the accessory device information received from communication device 212 until the received accessory device information matches the indicated total size. In this manner, computing system 105 may reassemble portions of accessory device information to reconstitute the entirety of the accessory device information.

In some examples, communication module 212 may generate a unique identifier for the accessory device information and include the unique identifier with each portion of the accessory device information transmitted by communication module 212. Computing system 105 may read these identifiers to combine only portions of accessory device information that are assigned to the same identifier. Communication module 212 may include a sequence identifier or the like with each portion of accessory device information and computing system 105 may use these sequence identifiers to reassemble the portions of accessory device information in the correct sequence. For example, the sequence identifier may be a numerical or other indicator capable of indicating the order or position of the portions of accessory device information relative to one another.

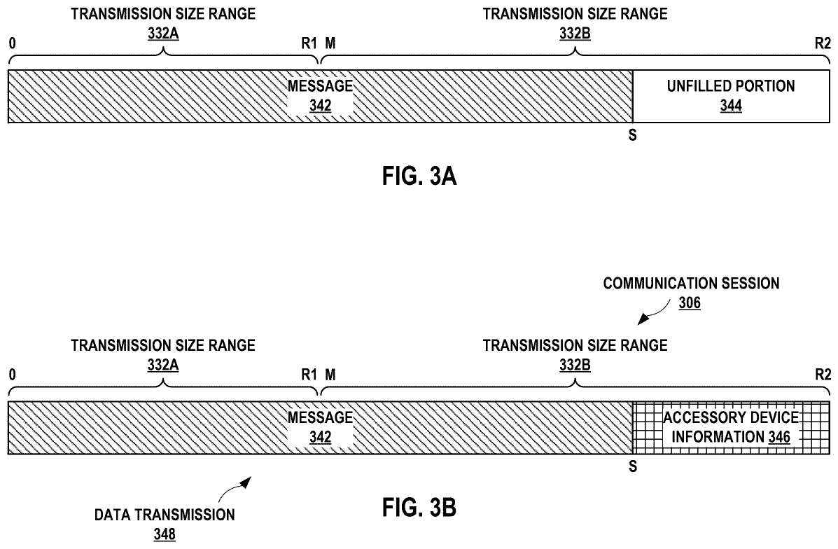

FIGS. 3A-3B are block diagrams illustrating an example process for piggybacking accessory device information over a user initiated non-terrestrial network connection, in accordance with one or more aspects of the present disclosure. Aspects of FIGS. 3A-3B may be described below in the context of FIGS. 1-2. For example, communication session 306 and transmission size ranges 332A-332B (collectively, “transmission size ranges 332”) may respectively be examples of communication session 106 of FIG. 1 and transmission size ranges 232 of FIG. 2.

In the example of FIG. 3A, a message 342 may have a size S, transmission size range 332A may have a minimum size of 0 and a maximum size of R1, and transmission size range 332B may have a minimum size of M (e.g., R1+1) and a maximum size of R2. Message 342 may represent a user-initiated message. Message 342 may have a corresponding transmission size range of transmission size ranges 332. In the example of FIG. 3A for instance, transmission size range 332B is the corresponding transmission size range for message 342 because transmission size range 332B is the transmission size range of transmission size ranges 332 that encompasses message 342. As can be seen, size S of message 342 falls between the minimum size, M, and maximum size, R2, of transmission size range 332B. Transmission size range 332A does not encompass message 342 in that size S not between the minimum size, 0, and maximum size, R1, of transmission size range 332A. As such, in this example, transmission size range 332A cannot be the corresponding transmission size range for message 342.

Communication module 112 may determine whether message 342 partially or fully fills the corresponding transmission size range. For example, communication module 112 may determine whether size S matches (e.g., is equal to) the maximum size of transmission size range 332B. When size S does match the maximum size of transmission size range 332B, communication module 112 may determine message 342 fully fills transmission size range 332B. When size S does not match the maximum size (e.g., is less than the maximum size), communication module 112 may determine message 342 partially fills transmission size range 332B. In response to determining message 342 partially fills transmission size range 332B, communication module 112 may piggyback accessory device information in a data transmission including message 342. For example, communication module 112 may identify an unfilled portion 344 of transmission size range 332B. For instance, communication module 112 may determine the difference in size between size S of message 342 and the maximum size R2 of transmission size range 332B. The difference in size (e.g., R2−S) may represent the size of unfilled portion 344. Unfilled portion 344 may accordingly represent the amount of space (e.g., number of bytes) within transmission size range 332B that is not used by message 342.

As shown in the example of FIG. 3B, communication module 112 may generate a data transmission 348 including message 342 and accessory device information 346. For instance, communication module 112 may include, in data transmission 348, message 342 and up to the total amount of space (e.g., bytes) of unfilled portion 344 with data from accessory device information 346. Communication module 112 may transmit data transmission 348 to NTN 102, such as through communication session 306. As such, data transmission 348 may represent a data packet sent to NTN 102. In some examples, communication module 112 may establish communication session 306 in response to an indication that the user intends to send message 342 via NTN 102. As described above for instance, communication module 112 may detect user-initiated messages, such as message 342 and, in response, establish communication session 306. Communication module 112 may establish communication session 306, transmit data transmission 348 through communication session 306, or both in response to detecting message 342.

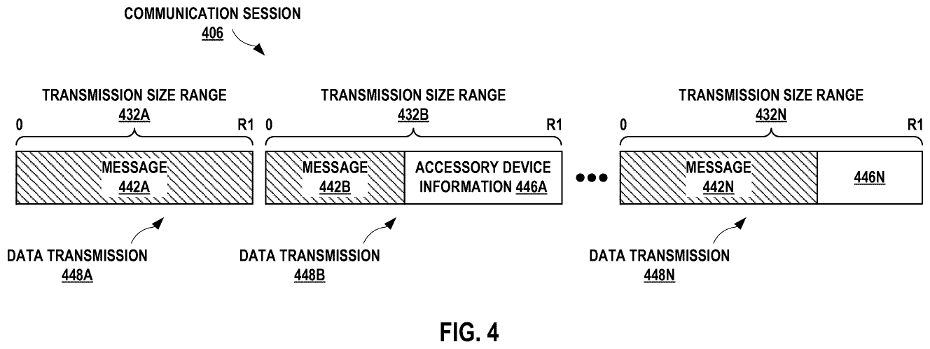

FIG. 4 is a block diagram illustrating an example communication session, in accordance with one or more aspects of the present disclosure. Aspects of FIG. 4 may be described below in the context of FIGS. 1-3. For example, communication session 406, transmission size ranges 432A-432N (collectively, “transmission size ranges 432”), messages 442A-442N (collectively, “messages 442”), accessory device information 446A-446N (collectively, “accessory device information 446”), and data transmissions 448A-448N (collectively, “data transmissions 448”) may respectively be an example of communication session 106 of FIG. 1 and transmission size ranges 332, message 342, accessory device information 346, and data transmission 348 of FIG. 3. In the example of FIG. 4, each of transmission size ranges 432A-432N respectively represent the corresponding transmission size range for each of data transmissions 448A-448N.

As can be seen, communication session 406 may include one or more of data transmissions 448. As shown by data transmission 448A, some (e.g., a subset) of data transmissions 448 may not be suitable for piggybacking of accessory device information 446. For example, transmission size range 432A of data transmission 448A is fully filled by message 442A. Accordingly, data transmission 448A cannot be used for piggybacking of accessory device information 446. In contrast, transmission size range 432B and transmission size range 432N are only partially filled (e.g., not fully filled) by their respective messages, message 442B and message 442N. Accordingly, data transmission 448B and data transmission 448N are only partially filled (e.g., not fully filled) by their respective messages, message 442B and message 442N, and can be used for piggybacking of accessory device information 446. As shown in the example of FIG. 4, communication module 112 may fill unfilled portions of data transmission 448B and data transmission 448N with accessory device information, such as accessory device information 446A and accessory device information 446N, respectively.

As described above, communication module 112 may transmit portions of accessory device information 446 in different data transmissions 448, such as when accessory device information 446 is too large to fit within the unfilled portion of a particular data transmission of data transmissions 448. As such, accessory device information 446A and accessory device information 446N may respectively represent the first and second portion of a single larger unit of accessory device information 446.

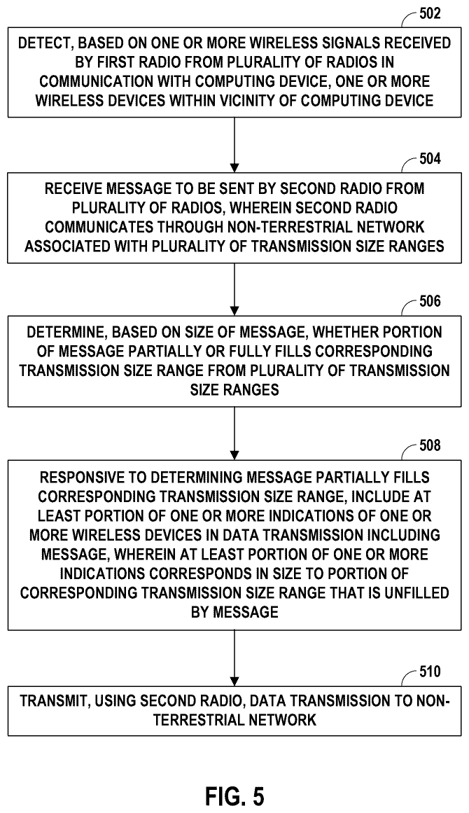

FIG. 5 is a flowchart of an example process for piggybacking accessory device information over a user initiated non-terrestrial network connection, in accordance with one or more aspects of the present disclosure. Aspects of FIG. 5 may be described below in the context of FIGS. 1-4.

Computing device 110 may detect, based on one or more wireless signals 122 received by a radio 116N from radios 116 in communication with computing device 110, one or more accessory devices 120 within a wireless range of computing device 110 (502). For example, accessory device 120A may transmit wireless signal 122A including a device discoverability advertisement, beacon, ping, or other message that radio 116N may receive. The wireless range may be a distance relative to computing device 110 within which radio 116N may receive wireless signals 122 from accessory devices 120.

Computing device 110 may receive a message 342 to be sent by a radio 116B, which communicates through an NTN 102 associated with a plurality of transmission size ranges 332 (504). For example, message 342 may include one or more of a text message, an emergency SOS, or an indication of a location of computing device 110. As described above, message 342 may represent a user-initiated message intended for transmission through NTN 102.

Computing device 110 may determine, based on a size of message 342, whether message 342 partially or fully fills a corresponding transmission size range 332B from transmission size ranges 332 (506). Each of transmission size ranges 332 may include a minimum size and a maximum size. As such, the corresponding transmission size range may be one of transmission size ranges having a minimum size and a maximum size that encompasses the size of message 342. As can be seen from the example of FIG. 3A for instance, transmission size range 332B may be considered the corresponding transmission size range because size S of message 342 is between the minimum size, M, and maximum size, R2, of transmission size range 332B. Transmission size ranges 332 may form a sequence of ranges where, for each successive transmission size range from transmission size ranges 332, the maximum size is larger than the minimum size and the minimum size is larger than the maximum size of a preceding transmission size range from transmission size ranges 332. An example of such a sequence of ranges is shown by the transmission size ranges of Table 1 above.

Responsive to determining message 342 partially fills corresponding transmission size range 332B, computing device 110 may include at least a portion of one or more indications of one or more accessory devices 120 (e.g., accessory device information 346) in a data transmission 348 including message 342, where the at least a portion of the one or more indications corresponds in size to a portion of the corresponding transmission size range 332B that is unfilled by message 342 (508). The one or more indications of one or more accessory devices 120 may represent accessory device information 346 for one or more accessory devices 120. As shown in the example of FIGS. 3A-3B for instance, computing device 110 may include at least a portion of accessory device information 346 in unfilled portion 344 to generate data transmission 348.

In some examples, computing device 110 may determine, using a location sensor 114, a change in location of computing device 110 relative to a previous location of computing device 110 satisfies a distance threshold. Computing device 110 may include at least the portion of the one or more indications of one or more accessory devices 120 in data transmission 348 responsive to determining that the change in location of computing device 110 relative to the previous location of computing device 110 satisfies the distance threshold (e.g., 50 ft, 100 ft, 200 ft) and determining that message 342 partially fills corresponding transmission size range 332B. Computing device 110 may have previously determined the previous location using location sensor 114. Computing device 110 may determine a current location of computing device 110 using location sensor 114 and compare the distance between the current location and the previous location to determine the change in location. Computing device 110 may determine the change in location satisfies the distance threshold when the change in location exceeds the distance threshold.

Computing device 110 may transmit, using radio 116B, data transmission 348 to NTN 102 (510). Computing device 110 may transmit, using second radio 116B, an indication of a location of one or more accessory devices 120 with data transmission 348 to NTN 102. The indication of the location of one or more accessory devices 120 may be based on the location of computing device 110. As described above, computing device 110 may determine, using location sensor 114, a location of computing device 110 and/or determine a relative location (e.g., distance between computing device 110 and one or more of accessory devices 120) of one or more accessory devices 120. The indication of the location of one or more accessory devices 120 may correspond to the location of the computing device, the relative location of one or more accessory devices 120, or other location information determined by computing device 110. In some examples, computing device 110 may combine locations and/or relative locations to form the indication of the location of one or more accessory devices 120.

In some examples, computing device 110 may transmit the one or more indications of one or more accessory devices 120 in separate portions. Referring to the example of FIG. 4 for instance, computing device 110 may have previously transmitted a first portion of the one or more indications (e.g., accessory device information 446A) within a first data transmission 448B. Subsequently, computing device 110 may transmit a second portion of the one or more indications (e.g., accessory device information 446N) within a second data transmission 448N. The second portion of the one or more indications may correspond in size to a portion of a corresponding one of transmission size ranges 432, in this example transmission size range 432N, that is unfilled by message 442N. Computing device 110 may transmit, using radio 116B, data transmission 448N to non-terrestrial network 102.

This disclosure includes the following examples.

Example 1: A method includes detecting, by a computing device and based on one or more wireless signals received by a first radio from a plurality of radios in communication with the computing device, one or more wireless devices within a wireless range of the computing device; receiving, by the computing device, a message to be sent by a second radio from the plurality of radios, wherein the second radio communicates through a non-terrestrial network associated with a plurality of transmission size ranges; determining, by the computing device and based on a size of the message, whether the message partially or fully fills a corresponding transmission size range from the plurality of transmission size ranges; responsive to determining the message partially fills the corresponding transmission size range, including, by the computing device, at least a portion of one or more indications of the one or more wireless devices in a data transmission including the message, wherein the at least a portion of the one or more indications corresponds in size to a portion of the corresponding transmission size range that is unfilled by the message; and transmitting, by the computing device and using the second radio, the data transmission to the non-terrestrial network.

Example 2: The method of example 1, further includes determining, by the computing device and using a location sensor, a change in location of the computing device relative to a previous location of the computing device satisfies a distance threshold, the previous location determined using the location sensor, wherein including at least the portion of the one or more indications of the one or more wireless devices in the data transmission is responsive to determining the change in location of the computing device relative to the previous location of the computing device satisfies the distance threshold and determining the message partially fills the corresponding transmission size range.

Example 3: The method of example 1, further includes determining, by the computing device and using a location sensor, a location of the computing device; and transmitting, by the computing device and using the second radio, an indication of a location of the one or more wireless devices with the data transmission to the non-terrestrial network, the indication of the location of the one or more wireless devices based on the location of the computing device.

Example 4: The method of example 1, wherein the at least a portion of the one or more indications is at least a first portion of the one or more indications and the message is a first message, the method further includes including at least a second portion of the one or more indications of the one or more wireless devices in a data transmission including a second message, wherein the at least a second portion of the one or more indications corresponds in size to a portion of a corresponding one of the plurality of transmission size ranges that is unfilled by the second message; and transmitting, by the computing device and using the second radio, the second data transmission to the non-terrestrial network.

Example 5: The method of example 1, wherein each of the plurality of transmission size ranges includes a minimum size and a maximum size.

Example 6: The method of example 5, wherein the plurality of transmission size ranges form a sequence of ranges where, for each successive transmission size range from the plurality of transmission size ranges, the maximum size is larger than the minimum size and the minimum size is larger than the maximum size of a preceding transmission size range from transmission size ranges.

Example 7: The method of example 1, wherein the message includes one or more of a text message, an emergency SOS, or an indication of a location of the computing device.

Example 8: A computing device includes a memory that stores instructions; and one or more processors that execute the instructions to: detect, based on one or more wireless signals received by a first radio from a plurality of radios in communication with the computing device, one or more wireless devices within a wireless range of the computing device; receive a message to be sent by a second radio from the plurality of radios, wherein the second radio communicates through a non-terrestrial network associated with a plurality of transmission size ranges; determine, based on a size of the message, whether the message partially or fully fills a corresponding transmission size range from the plurality of transmission size ranges; responsive to determining the message partially fills the corresponding transmission size range, include at least a portion of one or more indications of the one or more wireless devices in a data transmission including the message, wherein the at least a portion of the one or more indications corresponds in size to a portion of the corresponding transmission size range that is unfilled by the message; and transmit, using the second radio, the data transmission to the non-terrestrial network.

Example 9: The computing device of example 8, wherein the one or more processors execute the instructions to: determine, using a location sensor, a change in location of the computing device relative to a previous location of the computing device satisfies a distance threshold, the previous location determined using the location sensor, wherein including at least the portion of the one or more indications of the one or more wireless devices in the data transmission is responsive to determining the change in location of the computing device relative to the previous location of the computing device satisfies the distance threshold and determining the message partially fills the corresponding transmission size range.

Example 10: The computing device of example 8, wherein the one or more processors execute the instructions to: determine, using a location sensor, a location of the computing device; and transmit, using the second radio, an indication of a location of the one or more wireless devices with the data transmission to the non-terrestrial network, the indication of the location of the one or more wireless devices based on the location of the computing device.

Example 11: The computing device of example 8, wherein the at least a portion of the one or more indications is at least a first portion of the one or more indications and the message is a first message and the one or more processors execute the instructions to: include at least a second portion of the one or more indications of the one or more wireless devices in a data transmission including a second message, wherein the at least a second portion of the one or more indications corresponds in size to a portion of a corresponding one of the plurality of transmission size ranges that is unfilled by the second message; and transmit, using the second radio, the second data transmission to the non-terrestrial network.

Example 12: The computing device of example 8, wherein each of the plurality of transmission size ranges includes a minimum size and a maximum size.

Example 13: The computing device of example 12, wherein the plurality of transmission size ranges form a sequence of ranges where, for each successive transmission size range from the plurality of transmission size ranges, the maximum size is larger than the minimum size and the minimum size is larger than the maximum size of a preceding transmission size range from transmission size ranges.

Example 14: The computing device of example 8, wherein the message includes one or more of a text message, an emergency SOS, or an indication of a location of the computing device.

Example 15: Non-transitory computer-readable storage media including instructions, that when executed by one or more processors of a computing device, cause the one or more processors to: detect, based on one or more wireless signals received by a first radio from a plurality of radios in communication with the computing device, one or more wireless devices within a wireless range of the computing device; receive a message to be sent by a second radio from the plurality of radios, wherein the second radio communicates through a non-terrestrial network associated with a plurality of transmission size ranges; determine, based on a size of the message, whether the message partially or fully fills a corresponding transmission size range from the plurality of transmission size ranges; responsive to determining the message partially fills the corresponding transmission size range, include at least a portion of one or more indications of the one or more wireless devices in a data transmission including the message, wherein the at least a portion of the one or more indications corresponds in size to a portion of the corresponding transmission size range that is unfilled by the message; and transmit, using the second radio, the data transmission to the non-terrestrial network.

Example 16: The non-transitory computer-readable storage media of example 15, wherein the instructions, when executed by one or more processors, cause the one or more processors to: determine, using a location sensor, a change in location of the computing device relative to a previous location of the computing device satisfies a distance threshold, the previous location determined using the location sensor, wherein including at least the portion of the one or more indications of the one or more wireless devices in the data transmission is responsive to determining the change in location of the computing device relative to the previous location of the computing device satisfies the distance threshold and determining the message partially fills the corresponding transmission size range.

Example 17: The non-transitory computer-readable storage media of example 15, wherein the instructions, when executed by one or more processors, cause the one or more processors to: determine, using a location sensor, a location of the computing device; and transmit, using the second radio, an indication of a location of the one or more wireless devices with the data transmission to the non-terrestrial network, the indication of the location of the one or more wireless devices based on the location of the computing device.

Example 18: The non-transitory computer-readable storage media of example 15, wherein the at least a portion of the one or more indications is at least a first portion of the one or more indications and the message is a first message and the instructions, when executed by one or more processors, cause the one or more processors to: include at least a second portion of the one or more indications of the one or more wireless devices in a data transmission including a second message, wherein the at least a second portion of the one or more indications corresponds in size to a portion of a corresponding one of the plurality of transmission size ranges that is unfilled by the second message; and transmit, using the second radio, the second data transmission to the non-terrestrial network.

Example 19: The non-transitory computer-readable storage media of example 15, wherein each of the plurality of transmission size ranges includes a minimum size and a maximum size.

Example 20: The non-transitory computer-readable storage media of example 19, wherein the plurality of transmission size ranges form a sequence of ranges where, for each successive transmission size range from the plurality of transmission size ranges, the maximum size is larger than the minimum size and the minimum size is larger than the maximum size of a preceding transmission size range from transmission size ranges.

Example 21: The non-transitory computer-readable storage media of example 15, wherein the message includes one or more of a text message, an emergency SOS, or an indication of a location of the computing device.

Example 22: A computer-program product that includes instructions that cause one or more processors to perform any combination of the methods of examples 1-7.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise random-access memory (RAM), read-only memory (ROM), EEPROM, compact disc read-only memory (CD-ROM) or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
detecting, by a computing device and based on one or more wireless signals received by a first radio from a plurality of radios in communication with the computing device, one or more wireless devices within a wireless range of the computing device;
receiving, by the computing device, a message to be sent by a second radio from the plurality of radios, wherein the second radio communicates through a non-terrestrial network associated with a plurality of transmission size ranges;
determining, by the computing device and based on a size of the message, whether the message partially or fully fills a corresponding transmission size range from the plurality of transmission size ranges;
responsive to determining the message partially fills the corresponding transmission size range, including, by the computing device, at least a portion of one or more indications of the one or more wireless devices in a data transmission including the message, wherein the at least a portion of the one or more indications corresponds in size to a portion of the corresponding transmission size range that is unfilled by the message; and
transmitting, by the computing device and using the second radio, the data transmission to the non-terrestrial network.

2. The method of claim 1, further comprising:
determining, by the computing device and using a location sensor, that a change in location of the computing device relative to a previous location of the computing device satisfies a distance threshold, the previous location determined using the location sensor,
wherein including the at least a portion of the one or more indications of the one or more wireless devices in the data transmission is responsive to determining the change in location of the computing device relative to the previous location of the computing device satisfies the distance threshold and determining the message partially fills the corresponding transmission size range.

3. The method of claim 1, further comprising:
determining, by the computing device and using a location sensor, a location of the computing device; and
transmitting, by the computing device and using the second radio, an indication of a location of the one or more wireless devices with the data transmission to the non-terrestrial network, the indication of the location of the one or more wireless devices based on the location of the computing device.

4. The method of claim 1, wherein the at least a portion of the one or more indications is at least a first portion of the one or more indications and the message is a first message, the method further comprising:
including at least a second portion of the one or more indications of the one or more wireless devices in a data transmission including a second message, wherein the at least a second portion of the one or more indications corresponds in size to a portion of a corresponding one of the plurality of transmission size ranges that is unfilled by the second message; and
transmitting, by the computing device and using the second radio, the second data transmission to the non-terrestrial network.

5. The method of claim 1, wherein each of the plurality of transmission size ranges includes a minimum size and a maximum size.

6. The method of claim 5, wherein the plurality of transmission size ranges form a sequence of ranges where, for each successive transmission size range from the plurality of transmission size ranges, the maximum size is larger than the minimum size and the minimum size is larger than the maximum size of a preceding transmission size range from transmission size ranges.

7. The method of claim 1, wherein the message includes one or more of a text message, an emergency SOS, or an indication of a location of the computing device.

8. A computing device comprising:
a memory that stores instructions; and
one or more processors that execute the instructions to:
detect, based on one or more wireless signals received by a first radio from a plurality of radios in communication with the computing device, one or more wireless devices within a wireless range of the computing device;
receive a message to be sent by a second radio from the plurality of radios, wherein the second radio communicates through a non-terrestrial network associated with a plurality of transmission size ranges;
determine, based on a size of the message, whether the message partially or fully fills a corresponding transmission size range from the plurality of transmission size ranges;
responsive to determining the message partially fills the corresponding transmission size range, include at least a portion of one or more indications of the one or more wireless devices in a data transmission including the message, wherein the at least a portion of the one or more indications corresponds in size to a portion of the corresponding transmission size range that is unfilled by the message; and
transmit, using the second radio, the data transmission to the non-terrestrial network.

9. The computing device of claim 8, wherein the one or more processors execute the instructions to:
determine, using a location sensor, a change in location of the computing device relative to a previous location of the computing device satisfies a distance threshold, the previous location determined using the location sensor,
wherein including at least the portion of the one or more indications of the one or more wireless devices in the data transmission is responsive to determining the change in location of the computing device relative to the previous location of the computing device satisfies the distance threshold and determining the message partially fills the corresponding transmission size range.

10. The computing device of claim 8, wherein the one or more processors execute the instructions to:
determine, using a location sensor, a location of the computing device; and
transmit, using the second radio, an indication of a location of the one or more wireless devices with the data transmission to the non-terrestrial network, the indication of the location of the one or more wireless devices based on the location of the computing device.

11. The computing device of claim 8, wherein the at least a portion of the one or more indications is at least a first portion of the one or more indications and the message is a first message and the one or more processors execute the instructions to:
include at least a second portion of the one or more indications of the one or more wireless devices in a data transmission including a second message, wherein the at least a second portion of the one or more indications corresponds in size to a portion of a corresponding one of the plurality of transmission size ranges that is unfilled by the second message; and
transmit, using the second radio, the second data transmission to the non-terrestrial network.

12. The computing device of claim 8, wherein each of the plurality of transmission size ranges includes a minimum size and a maximum size.

13. The computing device of claim 12, wherein the plurality of transmission size ranges form a sequence of ranges where, for each successive transmission size range from the plurality of transmission size ranges, the maximum size is larger than the minimum size and the minimum size is larger than the maximum size of a preceding transmission size range from transmission size ranges.

14. The computing device of claim 8, wherein the message includes one or more of a text message, an emergency SOS, or an indication of a location of the computing device.

15. Non-transitory computer-readable storage media including instructions, that when executed by one or more processors of a computing device, cause the one or more processors to:
detect, based on one or more wireless signals received by a first radio from a plurality of radios in communication with the computing device, one or more wireless devices within a wireless range of the computing device;
receive a message to be sent by a second radio from the plurality of radios, wherein the second radio communicates through a non-terrestrial network associated with a plurality of transmission size ranges;
determine, based on a size of the message, whether the message partially or fully fills a corresponding transmission size range from the plurality of transmission size ranges;
responsive to determining the message partially fills the corresponding transmission size range, include at least a portion of one or more indications of the one or more wireless devices in a data transmission including the message, wherein the at least a portion of the one or more indications corresponds in size to a portion of the corresponding transmission size range that is unfilled by the message; and
transmit, using the second radio, the data transmission to the non-terrestrial network.

16. The non-transitory computer-readable storage media of claim 15, wherein the instructions, when executed by one or more processors, cause the one or more processors to:
determine, using a location sensor, a change in location of the computing device relative to a previous location of the computing device satisfies a distance threshold, the previous location determined using the location sensor,
wherein including at least the portion of the one or more indications of the one or more wireless devices in the data transmission is responsive to determining the change in location of the computing device relative to the previous location of the computing device satisfies the distance threshold and determining the message partially fills the corresponding transmission size range.

17. The non-transitory computer-readable storage media of claim 15, wherein the instructions, when executed by one or more processors, cause the one or more processors to:
determine, using a location sensor, a location of the computing device; and
transmit, using the second radio, an indication of a location of the one or more wireless devices with the data transmission to the non-terrestrial network, the indication of the location of the one or more wireless devices based on the location of the computing device.

18. The non-transitory computer-readable storage media of claim 15, wherein the at least a portion of the one or more indications is at least a first portion of the one or more indications and the message is a first message and the instructions, when executed by one or more processors, cause the one or more processors to:
include at least a second portion of the one or more indications of the one or more wireless devices in a data transmission including a second message, wherein the at least a second portion of the one or more indications corresponds in size to a portion of a corresponding one of the plurality of transmission size ranges that is unfilled by the second message; and
transmit, using the second radio, the second data transmission to the non-terrestrial network.

19. The non-transitory computer-readable storage media of claim 15, wherein each of the plurality of transmission size ranges includes a minimum size and a maximum size.

20. The non-transitory computer-readable storage media of claim 19, wherein the plurality of transmission size ranges form a sequence of ranges where, for each successive transmission size range from the plurality of transmission size ranges, the maximum size is larger than the minimum size and the minimum size is larger than the maximum size of a preceding transmission size range from transmission size ranges.
